(19) United States
(12) Patent Application Publication
(10) Pub. No.: US 2002/0148412 A1
(43) Pub. Date: Oct. 17, 2002

(54) Animal hydrotherapy pools

(76) Inventors: Bradley Russell Smith, Norfolk (GB); Catherine Elizabeth Smith, Norfolk (GB)

Correspondence Address: William M. Lee, Jr., Lee, Mann, Smith, McWilliams, Sweeney & Ohlson, P. O. Box 2786, Chicago, IL, 60690-2786, US

(21) Appl. No.: 09/835,739

(22) Filed: Apr. 16, 2001

(51) Int. Cl. A01K 29/00

(52) U.S. Cl. 119/673

(57) ABSTRACT

An animal hydrotherapy pool comprising a water container (10), controllable water jet nozzles (18, 18A) through which the water is recirculated, and preferably a ramp means (22, 24) for leading an animal into and out the pool with the aid of a collar attachable guide pole.

This invention relates to an animal hydrotherapy pool.

Hydrotherapy pools are especially but not exclusively used for exercising dogs, for example to aid loss of weight, but more generally to promote health and fitness and recovery from surgery.

According to one aspect of the invention, there is provided an animal hydrotherapy pool comprising a container for water, one or more nozzles in use for directing one or more jets of water into the water in the container, an extension of the wall of the container housing pump means for recirculating water from and back into the container via the nozzle or nozzles, and a control for the pump means on the container extension.

Rather than use of a remote pump unit, it is particularly advantageous to incorporate the pump means in the structure of the pool, and provide the pump means control in a position where the animal using the pool can simultaneously be controlled.

According to another aspect of the invention, there is provided an animal hydrotherapy pool comprising a container for water, said container being adapted to stand at least partially above ground at floor level, one or more nozzles in use for directing one or more jets of water into the water in the container, a pump means for recirculating water from and back into the container via the nozzle or nozzles, and a ramp means whereby an animal can be walked up the outside of the container into the pool and down into the water inside the container.

For convenience of the animal handler, who may wish to control the animal by means of a collar attached pole or the like, it is preferable for the container to stand at least partially above ground or floor level. However, this can make it difficult to get the animal in and out of the container, and the ramp means is convenient to overcome this problem.

The jet nozzles, which may conveniently be manually swivelable nozzles, are preferably located at one end of the container, whilst the ramp means preferably provides entrance for the animal into the container at the other end. A preferred shape for the container is rectangular. Locating the ramp at the opposite end to the nozzles helps to reduce water spillage.

If provision is made for heating the water, the heating means and means for recirculating water through it may also be accommodated, together with heater controls, in the extension of the container.

Moreover, if a filtering system is provided, this may also be accommodated in the container extension, especially if the filter system is based on use of a replaceable cartridge filter.

The pool may be supplied for at least partial burying into the ground or floor and may be plumbed into a mains water system or fillable with a hose. It is preferably supplied in conjunction with a guide pole which the handler can attach to the dog or other animal collar, not only to assist leading the animal into and out of the pool, but also to guide the animal in the water so that it is forced to swim against the force of the jets of water from the nozzles. The ability to swivel the nozzles enables the power of the water jets to be concentrated or dispersed, whereby to control the force of water against which the animal is caused to swim. As animals do not like being forced backwards in the water, the more concentrated the water force emanating from the jets the harder the animal is caused to swim in order to remain substantially stationary. The power of the water jets may therefore be controllable, in addition to the nozzles being swivelable, to vary the water pressure at the nozzles and thus the water force against which the animal is caused to swim. Again, the control for this purpose may be provided in the extension of the container.

An exemplary animal hydrotherapy pool in accordance with the invention is now described with reference to the accompanying drawings, in which:

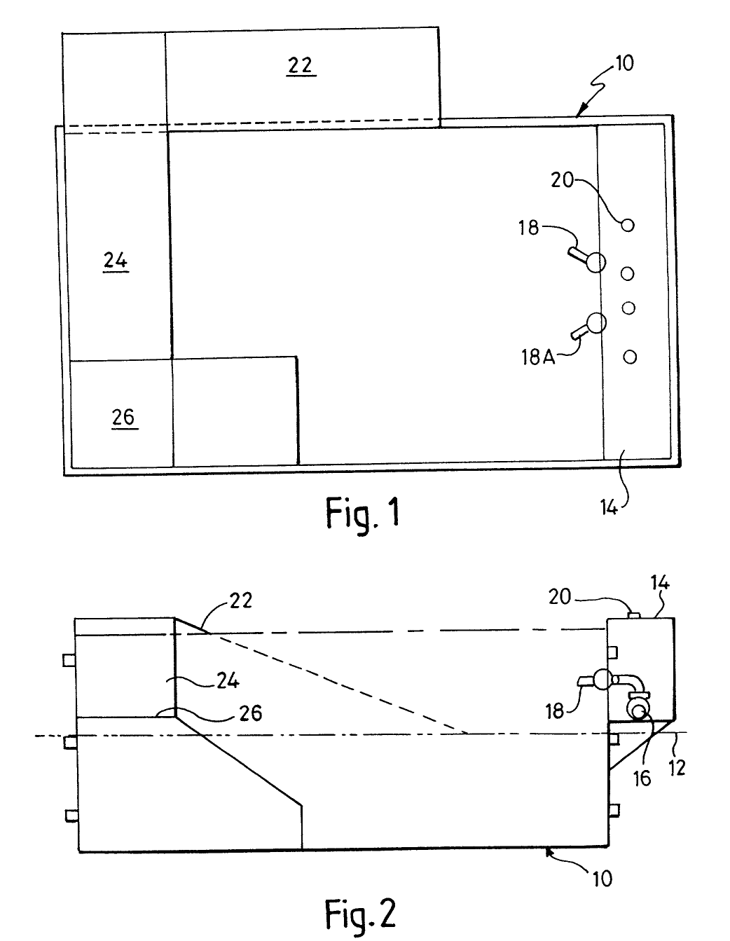

FIG. 1 is a plan view of a dog hydrotherapy pool; and

FIG. 2 is a side view of the pool.

Referring to the drawings, a plastics (such as polypropylene) container 10 forming the base and walls of the pool is generally rectangular in shape. In preferred practice, the container is sunk into the floor or ground to about half its height, which is typically just over 1 meter. Reference 12 in FIG. 2 indicates the ground line in this preferred practice. The pool may have various sizes, typically between 2 and 4 meters long and about 1½ meters wide.

At one end of the pool is an extension 14 constituting a housing for a pump 16. The pump 16 operates to recirculate water extracted through outlets and pipework (not shown) back into the pool via two high pressure nozzles 18, 18A, which jet water back into the pool from the extension end towards the remote end.

The nozzles 18, 18A are mounted on ball joint or like connectors, so that they can be manually swivelled to concentrate or diverge the jets, and thus alter the force of the water pressure acting down the longitudinal centre line of the pool.

Due to this water pressure, a dog guided, as by means of a guide pole attached to its collar, to swim towards the extension end of the pool where the jets are located, tends to be forced backwardly and, if the water pressure is increased, is caused to swim harder simply in order to maintain its position.

The dog can therefore be controllably exercised as appropriate to aid loss of weight or recovery from surgery, and more generally to promote health and fitness.

On/off controls and possibly direct water pressure controls 20 for the nozzles 18, 18A are conveniently placed on the extension 14 housing the water pump 16.

By virtue of sinking the pool in the ground or floor, leaving its top edge raised about ½ meter above ground or floor level, the dog handler is better able to control and guide a dog in the pool by means of the guide pole. On the other hand, it can with any dog other than a very small one be a problem to the handler to get the dog into the pool.

In order to overcome this problem, ramp means is provided at the end of the pool remote from the jets. As will be clear from FIGS. 1 and 2, this ramp means comprises an external ramp 22 from ground or floor level up the outside of the pool, and an interior ramp 24 leading down inside the pool to a platform 26 from which the dog can commence swimming. Conveniently, the dog handler can lead the dog into the pool with the guide pole already attached to its collar, preferably by means of a pivotting connector or a short lead. Once in the pool, the handler can guide the dog into the centre of the pool and cause it to swim towards the jets until the water pressure from the jets fully counteracts the swimming effort of the dog.

If desired, the water may be heated by use of a separate pump which circulates extracted water via a heater, and preferably also a water filter. Although no such means is illustrated, it may be convenient also to house the heater and filter in the container extension, which operational controls also provided on this extension. Incorporating all the ancillary equipment and controls therefor in the body of the pool unit is obviously advantageous for reducing installation costs, and is facilitated if a replaceable cartridge filter is employed.

It will be clear that the pool can readily be adapted for use by animals other than dogs.

1. An animal hydrotherapy pool comprising a container for water, said container being adapted to stand at least partially above ground at floor level, one or more nozzles in use for directing one or more jets of water into the water in the container, a pump means for recirculating water from and back into the container via the nozzle or nozzles, and a ramp means whereby an animal can be walked up the outside of the container into the pool and down into the water inside the container.

2. A pool according to claim 1, wherein the jet nozzles comprise manually swivelable nozzles.

3. A pool according to claim 1, wherein the nozzles are located at one end of the container, whilst the ramp means provides entrance for the animal into the container at the other end.

4. A pool according to any of claims 1 to 3, wherein the shape of the container is rectangular.

5. A pool according to any of claims 1 to 4, wherein the container is adapted for at least partial burying into the ground or floor.

6. A pool according to any of claims 1 to 5, adapted to be plumbed into a mains water system or fillable with a hose.

7. A pool according to any of claims 1 to 6, in combination with a guide pole attachable at one end to a collar of a dog or other animal, not only to assist in leading the animal into and out of the pool, but also to guide the animal in the water so that it is forced to swim against the force of the jets of water from the nozzles.

8. A pool according to any of claims 2 to 7, wherein the power of the water jets is controllable, in addition to the nozzles being swivelable.

9. An animal hydrotherapy pool as claimed in any of claims 1 to 8 further comprising an extension of the wall of the container, housing the pump means, and a control for the pump means on the container extension.

10. A pool according to claim 9, wherein, when provision is made for heating the water, the heating means and means for recirculating water through it are also accommodated, together with heater controls, in the extension of the container.

11. A pool according to claim 9 or 10, wherein, when a filtering system is provided, this is also accommodated in the container extension.

12. A pool according to claim 11, wherein the filter system is based on use of a replaceable cartridge filter.

13. A pool according to claim 8, wherein the control for jet power is provided in the extension of the container.

14. An animal hydrotherapy pool substantially as herein described with reference to the accompanying drawings.
